(19) United States
(12) Patent Application Publication
(10) Pub. No.: US 2017/0086472 A1
(43) Pub. Date: Mar. 30, 2017

(54) METHODS OF MAKING COFFEE WITH HIGH AMOUNTS OF PHENOLS AND CHLOROGENIC ACIDS

(71) Applicant: Robert Burns ARNOT, Stowe, VT (US)

(72) Inventor: Robert Burns ARNOT, Stowe, VT (US)

(73) Assignee: Epic Harvest LLC, Jackson, WY (US)

(21) Appl. No.: 15/275,589

(22) Filed: Sep. 26, 2016

Related U.S. Application Data
(60) Provisional application No. 62/222,821, filed on Sep. 24, 2015.

(51) Int. Cl. A23F 5/24; A23F 5/08; A23F 5/26; A23F 5/04

(52) U.S. Cl. CPC A23F 5/243; A23F 5/04; A23F 5/08; A23F 5/26

(57) ABSTRACT

A method of making coffee with predetermined amounts of phenols and chlorogenic acids that are beneficial to human health. Coffee beans are tested and selected as having predetermined amounts of phenols and chlorogenic acids. The selected coffee beans may be treated and then shipped to a predetermined location where they are roasted at a temperature and for a time period that preserves the phenols and chlorogenic acids therein without adversely affecting the taste and aroma thereof. The selected coffee beans are ground to a selected particle size and are brewed with water at a temperature and for a time period to produce liquid coffee having predetermined amounts of phenols and chlorogenic acids that are beneficial to human health.

### CROSS-REFERENCES TO RELATED APPLICATIONS

This application claims the priority of Provisional Patent Application No. 62/222,821 filed on Sep. 24, 2015.

### BACKGROUND OF THE INVENTION

I. Field of the Invention

The present invention relates to methods of making coffee with health benefits and, more particularly, to methods of making coffee having beneficial amounts of phenols, chlorogenic acids (CGAs), antioxidants and anti-inflammatory compounds.

II. Description of the Background Art

As shown in FIG. 1, coffee delivers the highest antioxidant content in the American diet, but the vast majority of coffee delivers far fewer antioxidants and anti-inflammatory compounds than it could and so delivers very little benefit with a host of negatives from high caffeine levels and fats to Acrylamides and HHQ. When tested for improvements in core health, most coffees have either a negative affect or a neutral affect meaning that they are either of no benefit to the consumer or pose a cardiovascular risk over time. This has been confirmed by tests that evidence that most coffees have a neutral or negative affect on endothelial cell function and vascular function when tested in humans.

Accordingly, a need exists for methods of making coffee that is robustly healthy for most people and that they will still enjoy with great taste and aroma. The methods of the present invention meet this need.

### BRIEF SUMMARY OF THE INVENTION

The new and improved methods of making coffee in accordance with the present invention generally include the following steps:

1. The testing and selection of coffee beans having a high amount of phenols, CGAs and antioxidants using High Performance Liquid Chromatography or Gas Chromatograph Mass Spectrometry;

2. The preparation and shipment of selected coffee beans to maintain their nutritional profiles, e.g., using a washed process, vacuum packing process, Grain Pro or any other suitable process;

3. The roasting of the selected coffee beans at an optimum roast time and temperature for preserving the highest amount of phenols, CGAs and antioxidants using roast profiles to preserve these elements and maximize flavor;

4. The grinding of the beans to maximize the total surface area exposed to water during brewing to provide maximal CGA extraction and a good taste profile;

5. The use and testing of commercial brewing techniques to determine those that provide the maximum extraction of CGAs, e.g., over 350 mg of chlorogenic acid (3, 4 and 5 caffeoylquinic acid) to a cup of coffee.

### BRIEF DESCRIPTION OF THE DRAWINGS

FIG. 1 is a chart showing the top ten sources of antioxidants in the U.S. diet;

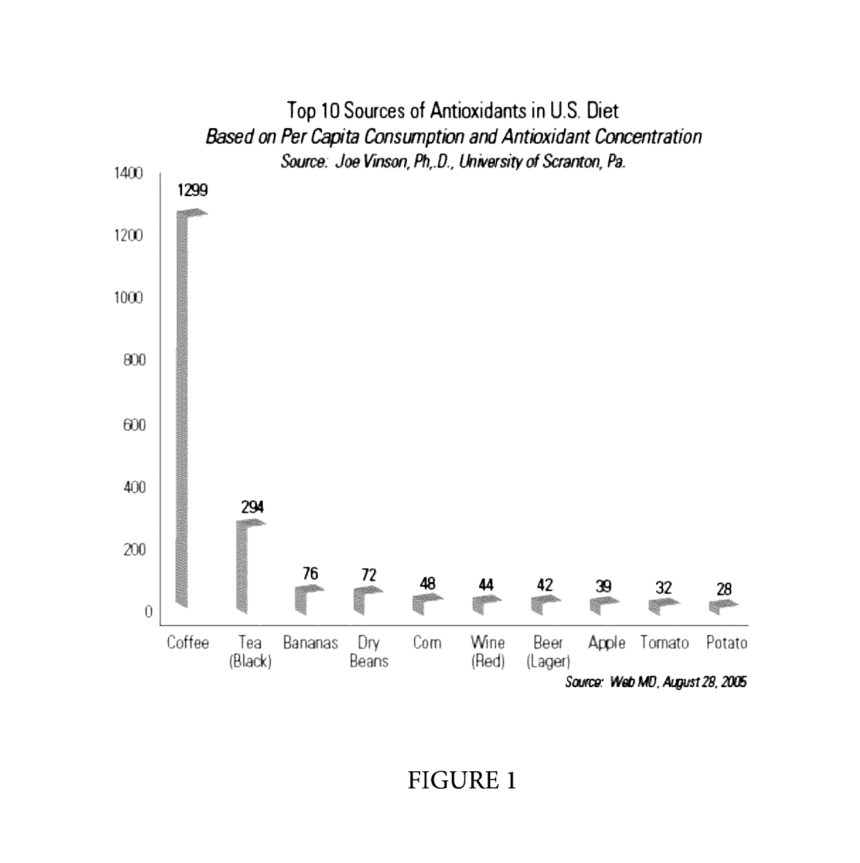

FIG. 2 is a summary of a scientific report from USDA in 2015 as to the benefits of coffee consumption;

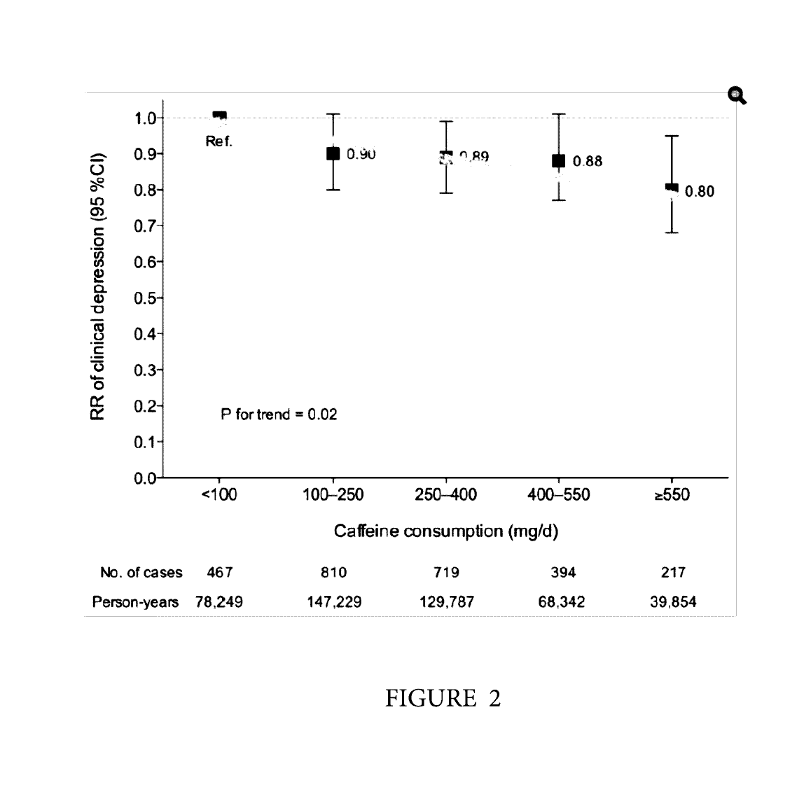

FIG. 3 is a summary of a report from the World Health Organization that coffee may protect against cancer;

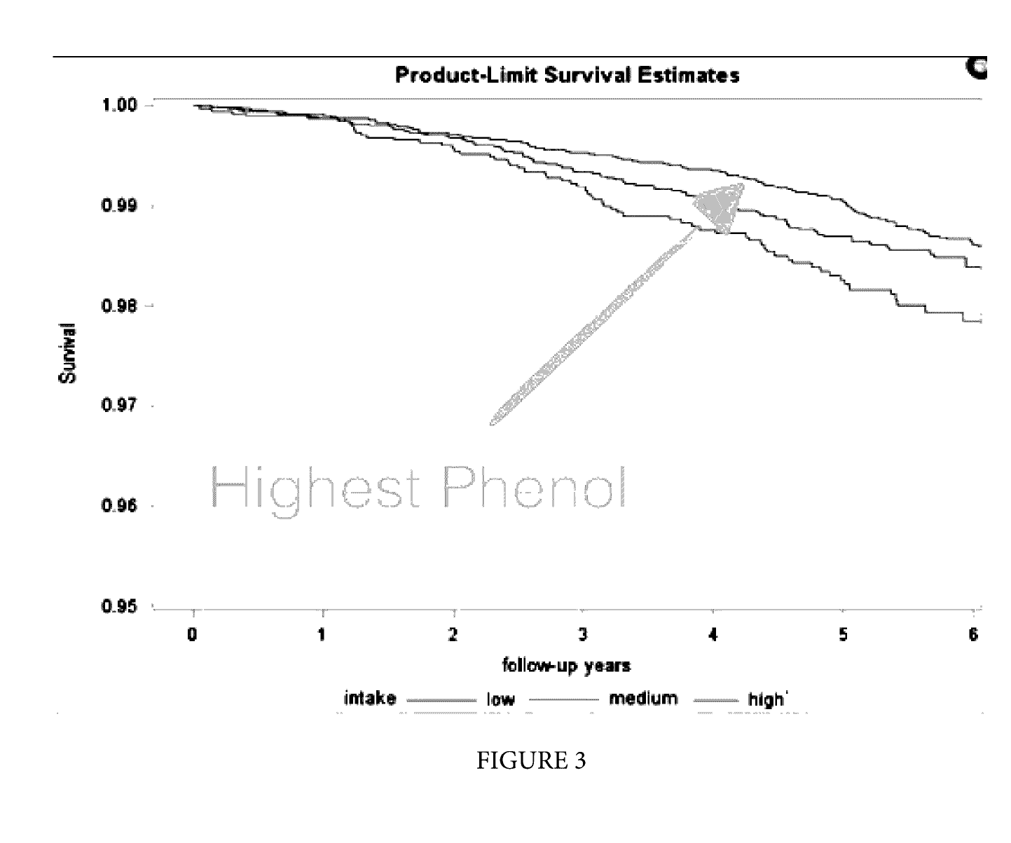

FIG. 4 is a summary of a 2012 report from the New England Journal of Medicine showing an association of coffee drinking and a decrease in all cause death for men and women;

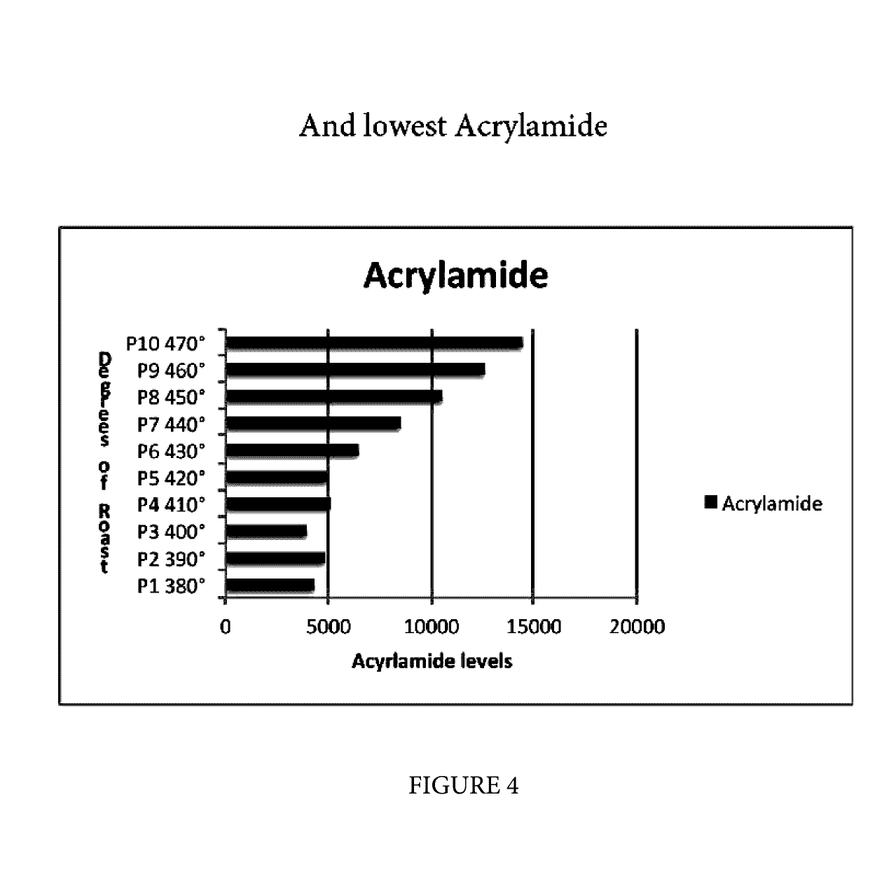

FIG. 5 is a chart showing that flavonoid intake improves heart health, blood sugar clearance, fat absorption and weight loss;

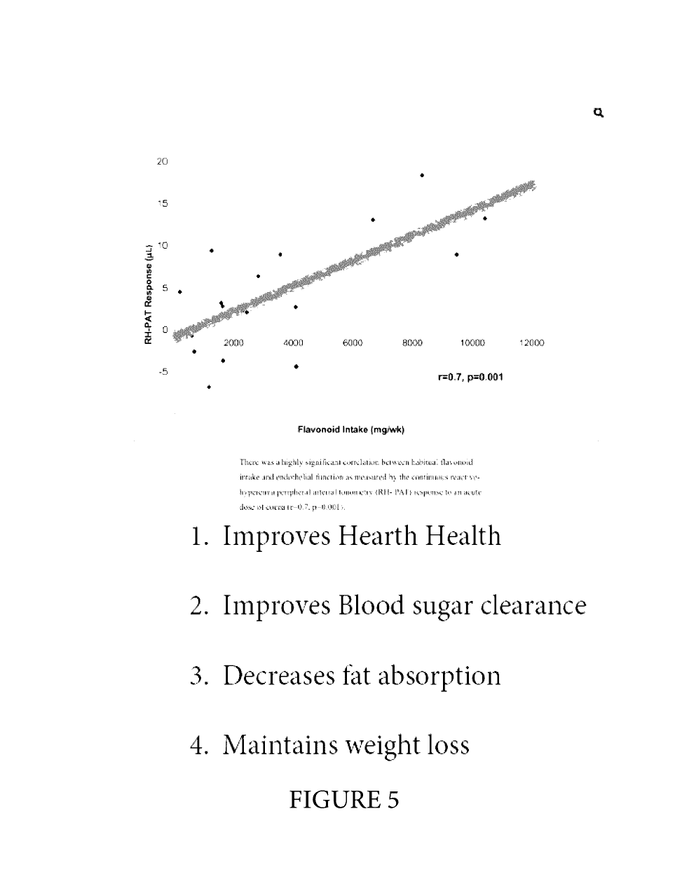

FIG. 6 is a chart showing that caffeine consumption by women can lessen depression;

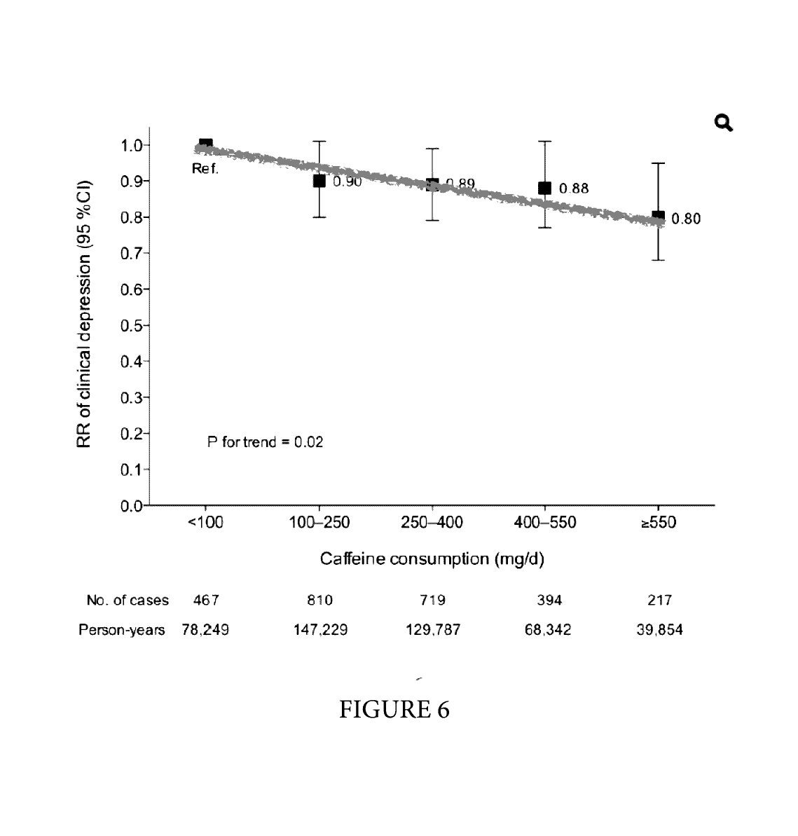

FIG. 7 is a chart showing that high phenol intake can result in a 30% decrease in all cause death; and

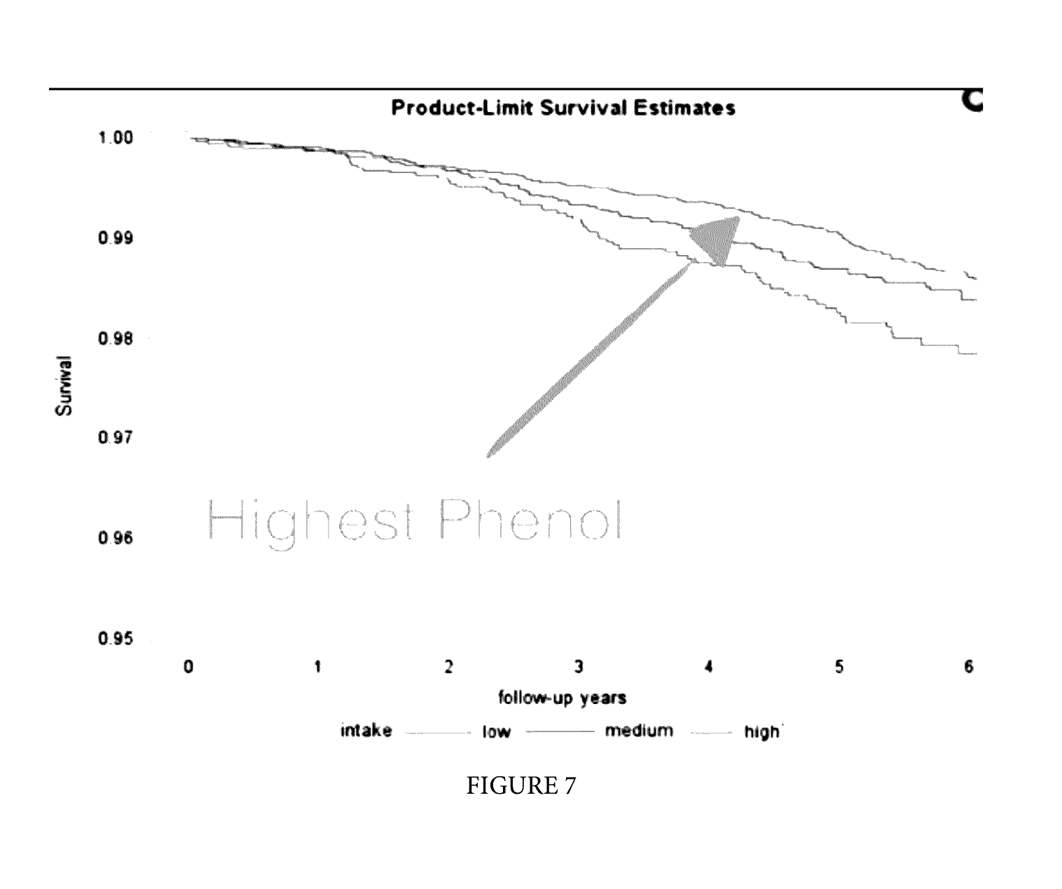

FIG. 8 is a chart showing that certain roast temperatures can decrease acrylamide levels.

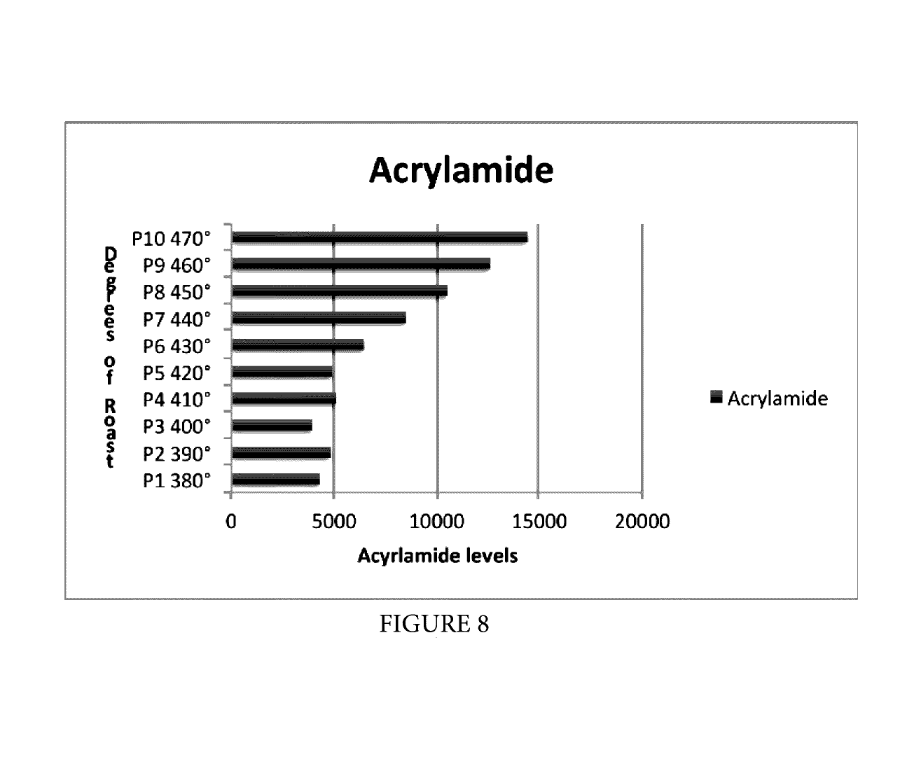

### DETAILED DESCRIPTION OF THE INVENTION

1. Testing and Selection of Coffee Beans Having a High Amount of Phenols, CGAs and Antioxidants

Various regions in Africa, Indonesia and South America were identified by looking at the right mix of altitude, latitude, soil, terroirs and cloud cover for coffee beans that would produce the highest natural polyphenol levels. It was determined that beans which are stressed the most protect themselves by manufacturing the largest amount of polyphenols. Accordingly, coffee beans were obtained from various regions in Brazil, Kenya, Ethiopia, Columbia, Rwanda, Congo and Indonesia where coffee was grown at high altitude. Chart No. 1 shows green beans tested by HPLC with significant variation in polyphenol levels from a high of 41844 to a low of 13595 mg/kg.

Also, the soil proved to be important so that certain beans had nearly double the phenol content of other beans in the same area. It was determined that volcanic soil also produces a high mineral and nutritional base for growing coffee.

2. The Preparation and Shipment of Selected Coffee Beans to Maintain Their Polyphenol Levels

Once coffee beans are selected and picked, their preparation plays an important role in how well they can maintain their nutritional profiles in shipping. Since the selected coffee beans may have a long trip by ship, for example, where they are exposed to heat, humidity and water, they are vacuum packed or placed in protective packing or the like to maintain their nutritional profiles in shipping.

3. The Roasting of the Selected Coffee Beans

It was determined that the roasting of the selected coffee beans for a time period of 7.5 to 12 minutes and a temperature range of 390° F. to 412° F. preserved the highest amount of phenols, CGAs and antioxidants. The following Chart No. 2 identifies the top selected coffee beans for total CGAs and phenols after roasting. This is significant because it shows the preservation of CGAs by the roast technology of the present invention. It is noted that the Ethiopian Homacho bean had the highest CGA after roasting. All commercially available coffees failed to deliver adequate amounts of CGAs and phenols after roasting, as shown in Chart No. 2, with many popular brands bought in a grocery store, Amazon or the like and tested in an independent laboratory by HPLC. The roast profile in Chart No. 2A below shows the destruction of polyphenols with increasing roast temperatures.

4. The Grinding of the Beans

It was determined that the grinding of the beans to maximize the total surface area exposed to water during brewing would provide maximal CGA extraction and a good taste profile. The extraction of CGAs from very coarse to powdered grinds was analyzed as well as measuring CGAs for grind size matched to brewing methods. It was determined that the finer the grind, the better the extraction of CGAs. The optimal grind sizes were found to be 100 microns to 1200 microns.

5. The Use and Testing of Brewing Techniques

Various brewing techniques were tested to determine those that provide the maximum extraction of CGAs, e.g., over 300 mg of 3, 4, and 5 chlorogenic acids to a cup of coffee (Approx. 7 oz). The maximum in the published literature is 188 mg/cup. The results of testing brewing techniques at approximately 210° F. for about 3.5 minutes are illustrated in the following Chart No. 3 showing values of 3, 4 and 5 CQA of over 1000 mg/cup.

From the foregoing description, it will be readily understood that the new and improved methods of making coffee in accordance with the present invention deliver the highest amounts of phenols, chlorogenic acids, antioxidants and anti-inflammatory compounds into a cup of coffee so that it is beneficial to human health.

We have also demonstrated that these high polyphenol coffees score among the very best tasting coffees as determined by the independent coffee review:

It is noted that the new and improved methods of the present invention produce high polyphenol, high chlorogenic coffee through completely natural means, i.e., nothing is added to the coffee. The results are accomplished through careful selection of the coffee beans, artisanal roasting and proper brewing, with no polyphenol degradation over time.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A method of making coffee with predetermined amounts of phenols and chlorogenic acids that are beneficial to human health, comprising:
testing and selection of coffee beans having predetermined amounts of phenols and chlorogenic acids;
treating and shipping the selected coffee beans to a predetermined location;
roasting the coffee beans at a temperature and for a time period that will preserve the phenols and chlorogenic acids therein without adversely affecting the taste and aroma thereof;
grinding the selected coffee beans to a desired particle size; and
brewing the roasted ground coffee with water to produce liquid coffee having predetermined amounts of phenols and chlorogenic acids that are beneficial to human health.

2. The method of claim 1 wherein the predetermined amounts of phenols and chlorogenic acids in the selected coffee beans are at least 14000 mg/kg and up to 42000 mg/kg of 3 caffeoyquinic acid.

3. The method of claim 1 wherein the selected coffee beans are roasted for a time period of 7.5 to 12 minutes at a temperature of 390° F. to 412° F.

4. The method of claim 3 wherein the time period is 10 minutes and the temperature is 390° F.

5. The method of claim 1 wherein the particle size is 100 microns to 1200 microns.

6. The method of claim 5 wherein the particle size is 100 microns.

7. The method of claim 1 wherein the roasted ground coffee is brewed to produce a cup of coffee having at least 350 mg of phenols and chlorogenic acids.

8. The method of claim 5 wherein the selected coffee beans are roasted for a time period of 7.5 to 12 minutes at a temperature of 390° F. to 412° F.

9. The method of claim 1 wherein the selected coffee beans are roasted for a time period of 7.5 to 12 minutes.

10. The method of claim 9 wherein the time period is 10 minutes.

11. The method of claim 1 wherein the selected coffee beans are roasted at a temperature of 390° F. to 412° F.

12. The method of claim 11 wherein the temperature is 390° F.

13. The method of claim 1 wherein the selected coffee beans are grown at high altitude or in environments that cause the selected beans to be stressed.

14. The method of claim 13 wherein the selected coffee beans are from Brazil, Kenya, Ethiopia, Columbia, Rwanda, Congo or Indonesia.

15. The method of claim 9 wherein the roasted ground coffee is brewed or extracted to produce a cup of coffee having at least 350 mg of phenols and chlorogenic acids.

16. The method of claim 15 wherein the roasted ground coffee is brewed at approximately 210° F. for about 3.5 minutes.
